(19) United States
(12) Patent Application Publication
(10) Pub. No.: US 2014/0087086 A1
(43) Pub. Date: Mar. 27, 2014

(54) Thermotropic Liquid Crystalline Powder

(71) Applicant: Ticona LLC, Florence, KY (US)

(72) Inventors: Kamlesh P. Nair, Florence, KY (US); James P. Shepherd, Independence, KY (US)

(73) Assignee: Ticona LLC, Florence, KY (US)

(21) Appl. No.: 14/027,287

(22) Filed: Sep. 16, 2013

Related U.S. Application Data
(60) Provisional application No. 61/706,277, filed on Sep. 27, 2012.
(60) Provisional application No. 61/786,855, filed on Mar. 15, 2013.

(51) Int. Cl. C09K 19/38

(52) U.S. Cl. CPC C09K 19/3809
USPC 427/447; 524/602; 524/603; 428/402; 427/180; 427/58

(57) ABSTRACT

A powder that contains microparticles formed from an aromatic polyester is provided. The mean size of the microparticles is generally from about 0.1 to about 40 micrometers. The microparticles may also have a shape that is generally spherical in nature. Regardless of the actual size and shape, however, the size distribution of the microparticles may be consistent throughout the powder. For example, at least about 50% by volume of the microparticles may have a mean size within a range of from about 0.1 to about 200 micrometers. Without intending to be limited by theory, the present inventor believes that a certain size and/or size distribution can improve the quality of coatings formed from the powder.

### RELATED APPLICATIONS

The present application claims priority to U.S. Provisional Application Ser. Nos. 61/706,277 (filed on Sep. 27, 2012) and 61/786,855 (filed on Mar. 15, 2013), which are incorporated herein in its entirety by reference thereto.

### BACKGROUND OF THE INVENTION

Wholly aromatic thermotropic liquid crystalline polymers (TLCPs) are an important class of engineering thermoplastics. These materials are known for their superior melt flow, excellent thermo-mechanical properties, and good chemical resistance. One problem with most conventional thermotropic liquid crystalline polymers, however, is that they cannot be readily formed into micro-sized powders because when mechanically ground, the polymers tend to form relatively fibrillar or flake-like particles due to their anisotropic, rigid rod-like nature. Unfortunately, this limits the ability of liquid crystalline polymers to be employed in various powder coating applications, such as thermal spraying. Various proposals have been made to overcome these deficiencies. For example, one such proposal involves a process in which a polymer having a flow beginning temperature of 239° C. is initially ground into coarse microparticles having a mean size of 500 μm with a cutter mill. The coarse particles are ground into fine microparticles having a mean size of 5.2 μm with a single track jet mill, and then heat treated under a nitrogen atmosphere. Despite achieving some improvements, however, problems nevertheless remain. For example, the multi-stage process that is required to form fine microparticles is overly complex and expensive. Furthermore, although small particle sizes can be achieved, the resulting powder can have a large particle size distribution, which can result in an increase in the extent of clogging while coating the powder onto a substrate, as well as resulting in coatings of a relatively poor quality.

As such, a need currently exists for a liquid crystalline polymer powder that can be readily formed with improved properties.

### SUMMARY OF THE INVENTION

In accordance with one embodiment of the present invention, a powder is disclosed that comprises a plurality of microparticles formed from an aromatic polyester having a melting temperature of from about 280° C. to about 380° C. The microparticles have a mean size of from about 0.1 to about 200 micrometers and at least about 50% by volume of the microparticles have a mean size within a range of from about 0.1 to about 200 micrometers.

In accordance with another embodiment of the present invention, a powder is disclosed that comprises a plurality of microparticles formed from an aromatic polyester. The microparticles have a mean size of from about 0.1 to about 200 micrometers, and the aromatic polyester contains aromatic biphenyl repeating units having the following general Formula I:

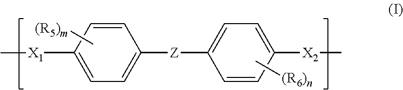

wherein,

R₅ and R₆ are independently halo, haloalkyl, alkyl, alkenyl, aryl, heteroaryl, cycloalkyl, or heterocyclyl;

m and n are independently from 0 to 4;

X₁ and X₂ are independently O, C(O), NH, C(O)HN, or NHC(O); and

Z is O or SO₂.

In accordance with yet another embodiment of the present invention, a method for forming a powder is disclosed that comprises providing a thermotropic liquid crystalline aromatic polyester that has a melting temperature of from about 280° C. to about 380° C., and forming the polyester into microparticles having a mean size of from about 0.1 to about 200 micrometers.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates an SEM microphotograph of the powder of Comparative Example 1;

FIGS. 2-3 illustrates SEM microphotographs of the powder of Example 2;

FIG. 4 illustrates an SEM microphotograph of the powder of Example 3; and

FIG. 5 illustrates an SEM microphotograph of the powder of Example 4.

### DETAILED DESCRIPTION

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 6 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C═C<). For example, (Cₓ—C_{y})alkenyl refers to alkenyl groups having from x to y carbon atoms and is meant to include for example, ethenyl, propenyl, 1,3-butadienyl, and so forth.

“Alkynyl” refers to refers to a linear or branched monovalent hydrocarbon radical containing at least one triple bond. The term “alkynyl” may also include those hydrocarbyl groups having other types of bonds, such as a double bond and a triple bond.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C< ring unsaturation.

“Halo” or “halogen” refers to fluoro, chloro, bromo, and iodo.

“Haloalkyl” refers to substitution of alkyl groups with 1 to 5 or in some embodiments 1 to 3 halo groups.

“Heteroaryl” refers to an aromatic group of from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other functional groups as is known in the art. For example, an aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents. When incorporated into the polymer of the present invention, such substitutions may be pendant or grafted groups, or may themselves form part of the polymer backbone. For example, in Formula I below, R₁ and/or R₂ may be a sulfonyl- or oxy-substituted aryl group in that the sulfonyl group (—SO₂—) or oxy group (—O—) is contained within the polymer backbone and links together the phenyl group with the aryl substitution.

It is to be understood by one of ordinary skill in the art that the present discussion is a description of exemplary embodiments only, and is not intended as limiting the broader aspects of the present invention.

Generally speaking, the present invention is directed to a powder that contains microparticles formed from an aromatic polyester. The mean size of the microparticles is generally from about 0.1 to about 200 micrometers, in some embodiments, in some embodiments from about 0.1 to about 100 micrometers, in some embodiments from about 0.1 to about 40 micrometers, in some embodiments from about 0.2 to about 30 micrometers, in some embodiments from about 0.5 to about 20 micrometers, and in some embodiments, from about 1 to about 15 micrometers. As used herein, the mean size of a microparticle may refer to its mean length, width, and/or height, and can be determined by optical microscopy as the average size of diameters measured at 2 degree intervals passing through a particle's geometric center. The microparticles may also possess a relatively low “aspect ratio” (mean length and/or width divided by the mean height). For example, the aspect ratio of the microparticles may be from about 0.4 to about 2.0, in some embodiments from about 0.5 to about 1.5, and in some embodiments, from about 0.8 to about 1.2 (e.g., about 1). In one embodiment, for example, the microparticles may have a shape that is generally spherical in nature. Regardless of the actual size and shape, however, the present inventor has found that the size distribution of the microparticles may be generally consistent throughout the powder. That is, at least about 50% by volume of the microparticles, in some embodiments at least about 70% by volume of the microparticles, and in some embodiments, at least about 90% by volume of the microparticles (e.g., 100% by volume) may have a mean size within a range of from about 0.1 to about 200 micrometers, in some embodiments from about 0.2 to about 150 micrometers, in some embodiments from about 0.5 to about 100 micrometers, and in some embodiments, from about 1 to about 50 micrometers. Without intending to be limited by theory, the present inventor believes that a certain size and/or size distribution can improve the quality of coatings formed from the powder.

To help achieve the desired particle characteristics, the aromatic polyester typically contains a biphenyl repeating unit. Without intending to be limited by theory, it is believed that certain types of biphenyl repeating units can disrupt the linear nature of the polymer backbone, thereby facilitating the formation of fine particles at a relatively high consistency. The nature and relative concentration of the biphenyl repeating units are generally selected to achieve the desired particle characteristics. For example, biphenyl repeating units may constitute from about 0.5 mol. % to about 40 mol. %, in some embodiments from about 0.5 mol. % to about 30 mol. %, in some embodiments from about 1 mol. % to about 25 mol. %, and in some embodiments, from about 1.5 mol. % to about 10 mol. % of the polymer. The biphenyl repeating units generally have the following general formula I:

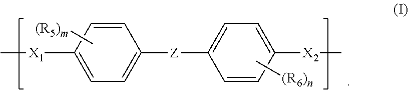

wherein,

R₅ and R₆ are independently halo, haloalkyl, alkyl, alkenyl, aryl, heteroaryl, cycloalkyl, or heterocyclyl;

m and n are independently from 0 to 4, in some embodiments from 0 to 1, and in one particular embodiment, 0;

X₁ and X₂ are independently O, C(O), NH, C(O)HN, or NHC(O); and

Z is O or SO₂.

In one particular embodiment, m and n are 0 in Formula I and Z is SO₂ such that the biphenyl repeating unit is a sulfonyl unit having the following Formula (II):

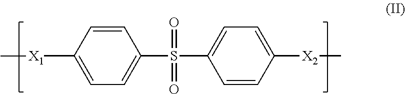

wherein, X₁ and X₂ are independently O, C(O), NH, C(O)HN, or NHC(O). For example, X₁ and/or X₂ may be 0 and/or NH.

The repeating units represented in Formula I and/or Formula II above may be derived from a variety of different biphenyl precursor monomers, including, for example, biphenyl alcohols (e.g., 4-(4-hydroxyphenyl)-sulfonylphenol, 4-(4-aminophenyl)sulfonylphenol, 4-(4-aminophenoxy)phenol, 4-(4-hydroxyphenoxy)-phenol, etc.); biphenyl amines (e.g., 4-(4-aminophenyl)sulfonylaniline, 4-(4-aminophenoxy)aniline, etc.); biphenyl acids (e.g., 4-(4-carboxyphenyl)-sulfonylbenzoic acid, 4-(4-formylphenoxy)benzaldehyde, etc.); biphenyl amides (e.g., 4-(4-carbamoylphenyl)sulfonylbenzamide, N-[4-(4-formamidophenyl)-sulfonylphenyl]formamide, 4-(4-carbamoylphenoxy)benzamide, etc.); and so forth, as well as combinations thereof.

In addition to biphenyl repeating units, the aromatic polyester also contains one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The resulting copolymer may have any desired copolymer configuration known in the art, such as a block copolymer, grafted copolymer, random copolymer, etc.

The aromatic ester repeating units may be generally represented by the following Formula (III):

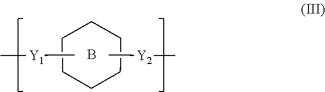

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O), wherein at least one of Yⱼ and Y₂ are C(O).

Examples of aromatic ester repeating units that are suitable for use in the present invention may include, for instance, aromatic dicarboxylic repeating units (Y₁ and Y₂ in Formula II are C(O)), aromatic hydroxycarboxylic repeating units (Y₁ is O and Y₂ is C(O) in Formula II), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”) and isophthalic acid (“IA”). When employed, repeating units derived from aromatic dicarboxylic acids (e.g., IA and/or TA) typically constitute from about 5 mol. % to about 60 mol. %, in some embodiments from about 10 mol. % to about 55 mol. %, and in some embodiments, from about 15 mol. % to about 50% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. One particularly suitable aromatic hydroxycarboxylic acid is 4-hydroxybenzoic acid (“HBA”). When employed, repeating units derived from hydroxycarboxylic acids (e.g., HBA) typically constitute from about 10 mol. % to about 85 mol. %, in some embodiments from about 20 mol. % to about 80 mol. %, and in some embodiments, from about 25 mol. % to about 75% of the polymer.

While a wide variety of aromatic ester repeating units may be employed, the polymer may nevertheless be “low naphthenic” in certain embodiments to the extent that it contains a minimal content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) is typically no more than about 35 mol. %, in some embodiments no more than about 30 mol. %, in some embodiments no more than about 25 mol. %, in some embodiments no more than about 20 mol. %, in some embodiments no more than about 15 mol. %, and in some embodiments, from 0 mol. % to about 10 mol. % of the polymer (e.g., 0 mol. %). Despite the absence of a high level of conventional naphthenic acid repeating units, the present inventor has discovered that selective control over the type and relative concentration of the aromatic sulfonyl repeating units can lead to “low naphthenic” polymers that are not only soluble in certain solvents, but also capable of exhibiting good mechanical and electrical properties.

Other repeating units may also be employed in the polymer. In certain embodiments, for instance, repeating units may be employed that are derived from aromatic dials, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic dials (e.g., HQ and/or BP) typically constitute from about 1 mol. % to about 30 mol. %, in some embodiments from about 2 mol. % to about 25 mol. %, and in some embodiments, from about 5 mol. % to about 20% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In one particular embodiment, the aromatic polyester may be formed from repeating units derived from a sulfonyl alcohol and/or sulfonyl amine (e.g., 4-(4-hydroxyphenyl)sulfonylphenol, or 4-(4-aminophenyl)-sulfonylaniline), 4-hydroxybenzoic acid (“HBA”), and terephthalic acid (“TA”) and/or isophthalic acid (“IA”), as well as various other optional constituents. The repeating units derived from the sulfonyl compound may constitute from about 5 mol. % to about 50 mol. %, in some embodiments from about 10 mol. % to about 40 mol. %, and in some embodiments, from about 15 mol. % to about 30 mol. % of the polymer. The repeating units derived from 4-hydroxybenzoic acid (“HBA”) may constitute from about 5 mol. % to about 70 mol. %, in some embodiments from about 10 mol. % to about 65 mol. %, and in some embodiments, from about 15 mol. % to about 50% of the polymer. The repeating units derived from terephthalic acid (“TA”) and/or isophthalic acid (“IA”) may likewise constitute from about 5 mol. % to about 40 mol. %, in some embodiments from about 10 mol. % to about 35 mol. %, and in some embodiments, from about 15 mol. % to about 35% of the polymer. Other possible repeating units may include those derived from 4,4′-biphenol (“BP”), hydroquinone (“HQ”), and/or acetaminophen (“APAP”). In certain embodiments, for example, repeating units derived from BP, HQ, and/or APAP may each constitute from about 1 mol. % to about 30 mol. %, in some embodiments from about 2 mol. % to about 25 mol. %, and in some embodiments, from about 3 mol. % to about 20 mol. % when employed. If desired, the polymer may also contain a relatively low amount of repeating units derived from naphthenic monomers (6-hydroxy-2-naphthoic acid (“HNA”) or 2,6-naphthalenedicarboxylic acid (“NDA”) within the ranges noted above.

In another embodiment, the aromatic polyester may be formed from repeating units derived from a sulfonyl alcohol and/or sulfonyl amine, 4-hydroxybenzoic acid (“HBA”), 4′-biphenol (“BP”) and/or hydroquinone (“HQ”), as well as various other optional constituents. The repeating units derived from the sulfonyl compound may constitute from about 0.1 mol. % to about 15 mol. %, in some embodiments from about 0.5 mol. % to about 10 mol. %, and in some embodiments, from about 1 mol. % to about 5 mol. % of the polymer. The repeating units derived from 4-hydroxybenzoic acid (“HBA”) may constitute from about 40 mol. % to about 85 mol. %, in some embodiments from about 50 mol. % to about 80 mol. %, and in some embodiments, from about 60 mol. % to about 75% of the polymer. The repeating units derived from 4′-biphenol (“BP”) and/or hydroquinone (“HQ”) may likewise constitute from about 5 mol. % to about 40 mol. %, in some embodiments from about 10 mol. % to about 35 mol. %, and in some embodiments, from about 15 mol. % to about 35% of the polymer. Other possible repeating units may include those derived from terephthalic acid (“TA”), isophthalic acid (“IA”), and/or acetaminophen (“APAP”). In certain embodiments, for example, repeating units derived from IA, TA, and/or APAP may each constitute from about 1 mol. % to about 30 mol. %, in some embodiments from about 2 mol. % to about 25 mol. %, and in some embodiments, from about 3 mol. % to about 20 mol. % when employed. If desired, the polymer may also contain a relatively low amount of repeating units derived from naphthenic monomers (6-hydroxy-2-naphthoic acid (“HNA”) or 2,6-naphthalenedicarboxylic acid (“NDA”) within the ranges noted above.

Although not necessarily a requirement, the resulting aromatic polyester is generally classified as a “thermotropic liquid crystalline” polymer to the extent that it can possess a rod-like structure and exhibit a crystalline behavior in its molten state (e.g., thermotropic nematic state). The polymer may possess a fully crystalline, semi-crystalline, or amorous-like structure under certain circumstances. For example, when dissolved in a solvent, the polymer may exhibit amorphous-like properties in that it becomes transparent and lacks an identifiable melting point. Yet, after heat treatment and solvent removal, the polymer may exhibit a highly-ordered crystalline structure in which the molecules are aligned. Contrary to many conventional liquid crystalline polymers, however, the polymer may nevertheless exhibit macroscopically isotropic electrical and/or mechanical properties.

Regardless of the particular constituents and nature of the polymer, the aromatic polyester may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

The aromatic sulfonyl precursor monomer (e.g., aromatic sulfonyl alcohol, acid, amine, amide, etc.) may also be added to the polymerization apparatus. Although it may be introduced at any time, it is typically desired to apply the aromatic sulfonyl monomer before melt polymerization has been initiated, and typically in conjunction with the other aromatic precursor monomers for the polymer. The relative amount of the aromatic sulfonyl monomer added to the reaction mixture may be selected to help achieve a balance between solubility and mechanical properties as described above. In most embodiments, for example, aromatic sulfonyl monomer(s) constitute from about 0.1 wt. % to about 35 wt. %, in some embodiments from about 0.5 wt. % to about 30 wt. %, and in some embodiments, from about 1 wt. % to about 25 wt. % of the reaction mixture.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 250° C. to about 380° C., and in some embodiments, from about 280° C. to about 380° C. For instance, one suitable technique for forming the aromatic polyester may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 280° C. to about 380° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

The resulting aromatic polyester can have a relatively high melting temperature. For example, the melting temperature of the polyester may be from about 280° C. to about 380° C., in some embodiments from about 290° C. to about 360° C., and in some embodiments, from about 300° C. to about 350° C. Of course, polymers with lower melting temperatures may also be employed in the present invention, such as those with a melting point of from about 225° C. to about 280° C., and in some embodiments, from about 245° C. to about 275° C. Regardless, the polyester can maintain a relatively low melt viscosity. The melt viscosity of the aromatic polyester may, for instance, be about 200 Pa-s or less, in some embodiments about 150 Pa-s or less, and in some embodiments, from about 50 to about 125 Pa-s, determined at a shear rate of 1000 seconds⁻¹. Melt viscosity may be determined in accordance with ASTM Test No. 1238-70 at temperatures ranging from 320° C. to 370° C. depending on the melting temperature (e.g., 350° C. or 370° C.). The resulting aromatic polyester may also have a high number average molecular weight (Mₙ) of about 2,000 grams per mole or more, in some embodiments from about 4,000 grams per mole or more, and in some embodiments, from about 5,000 to about 50,000 grams per mole. The intrinsic viscosity of the polymer, which is generally proportional to molecular weight, may also be relatively high. For example, the intrinsic viscosity may be about 1 deciliters per gram (“dL/g”) or more, in some embodiments about 2 dL/g or more, in some embodiments from about 3 to about 20 dL/g, and in some embodiments from about 4 to about 15 dL/g. Intrinsic viscosity may be determined in accordance with ISO-1628-5 using a 50/50 (v/v) mixture of pentafluorophenol and hexafluoroisopropanol, as described in more detail below.

Once formed, the resulting polymer may be formed into a powder using a variety of different powder formation techniques. Examples of such powder formation techniques may include wet techniques (e.g., solvent evaporation, spray drying, etc.), dry techniques (e.g., grinding, granulation, etc.), and so forth. In one particular embodiment, for example, the polymer may be ground using a jaw crusher, gyratory crusher, cone crusher, roll crusher, impact crusher, hammer crusher, cracking cutter, rod mill, ball mill, vibration rod mill, vibration ball mill, pan mill, roller mill, impact mill, discoid mill, stirring grinding mill, fluid energy mill, jet mill, etc. Jet milling, for instance, typically involves the use of a shear or pulverizing machine in which the polymer is accelerated by gas flows and pulverized by collision. Any type of jet mill design may be employed, such as double counterflow (opposing jet) and spiral (pancake) fluid energy mills. Gas and particle flow may simply be in a spiral fashion, or more intricate in flow pattern, but essentially particles collide against each other or against a collision surface. In certain embodiments, it may be desired to mill the polymer in the presence of a cryogenic fluid (e.g., dry ice, liquid carbon dioxide, liquid argon, liquid nitrogen, etc.) to produce a low-temperature environment in the system. The low-temperature environment chills the polymer below its glass transition point to facilitate grinding in a mill that applies impact or shear, such as a jet-mill.

Regardless of the particular technique employed, one beneficial aspect of the present invention is that fine particles may be formed without the need for additional heat treatment steps. This is due in part to the ability of the aromatic polyester to achieve relatively high melting temperatures, such as described above, prior to powder formation. Furthermore, in addition to avoiding the need for a heat treatment after powder formation, the fine particles of the present invention can be formed with a single powder formation step. Once again, this is due in part to the unique ability of the aromatic polyester to readily form particles having a small size and consistent distribution. Thus, the conventional processing steps of forming coarse particles and heat treatment are not necessarily required in the present invention. Nevertheless, if desired, such processing steps may be employed in certain embodiments. When employed, for instance, heat treatment may be conducted during and/or after powder formation using various techniques as is known in the art. The heat-treatment may include, for example, a method in which the microparticles are heated at a temperature of about 150° C. to about 350° C. in the presence of a high boiling point solvent (e.g., diphenyl ether, diphenylsulfone, etc.) or inert gas atmosphere (e.g., nitrogen, helium, argon, etc.).

If desired, the powder may also employ one or more additives in conjunction with the aromatic polyester microparticles. Examples of such additives may include, for instance, viscosity modifiers, antimicrobials, pigments, antioxidants, stabilizers, surfactants, waxes, flow promoters, solid solvents, inorganic and organic fillers, and other materials added to enhance properties and processibility. For example, a filler material may be incorporated with the polymer composition to enhance strength. A filler composition can include a filler material such as a fibrous filler and/or a mineral filler and optionally one or more additional additives as are generally known in the art. Mineral fillers may, for instance, be employed in the polymer composition to help achieve the desired mechanical properties and/or appearance. When employed, mineral fillers typically constitute from about 5 wt. % to about 60 wt. %, in some embodiments from about 10 wt. % to about 55 wt. %, and in some embodiments, from about 20 wt. % to about 50 wt. % of the polymer composition.

Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na, Ca)_{0.33}(Al,Mg)₂Si₄O₁₀(OH)₂.nH₂O), vermiculite ((MgFe,Al)₃(Al,Si)₄O₁₀(OH)₂. 4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable fillers may include boron nitride, calcium silicate, aluminum silicate, mica, diatomaceous earth, wollastonite, alumina, silica, titanium dioxide, calcium carbonate, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof. Nano-sized inorganic filler particles (e.g., diameter of about 100 nanometers or less) may also be employed in certain embodiments to help improve the flow properties of the composition. Examples of such particles may include, for instance, nanoclays, nanosilica, nanoalumina, etc. In yet another embodiment, inorganic hollow spheres (e.g., hollow glass spheres) may also be employed in the composition to help decrease the dielectric constant of the composition for certain applications.

Fibers may also be employed as a filler material to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulating property, which is often desirable for use in electronic components, the high strength fibers may be formed from materials that are also generally insulating in nature, such as glass, ceramics (e.g., alumina or silica), aramids (e.g., Kevlar® marketed by E.I. du Pont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof. When employed, fibrous fillers typically constitute from about 5 wt. % to about 60 wt. %, in some embodiments from about 10 wt. % to about 55 wt. %, and in some embodiments, from about 20 wt. % to about 50 wt. % of the powder.

Regardless of its constituents, the resulting powder may possess good electrical properties for use in a wide variety of applications. For instance, the powder and/or the polyester itself may have a relatively low dielectric constant that allows it to be employed as a heat dissipating material in various electronic applications (e.g., flexible printed circuit boards). For example, the average dielectric constant may be about 5.0 or less, in some embodiments from about 0.1 to about 4.5, and in some embodiments, from about 0.2 to about 3.5, as determined by the split post resonator method at a variety of frequencies, such as from about 1 to about 15 GHz (e.g., 1, 2, or 10 GHz). The dissipation factor, a measure of the loss rate of energy, may also be relatively low, such as about 0.0060 or less, in some embodiments about 0.0050 or less, and in some embodiments, from about 0.0010 to about 0.0040, as determined by the split post resonator method at a variety of frequencies, such as from about 1 to about 15 GHz (e.g., 1, 2, or 10 GHz).

The powder may be used in a wide variety of applications. For example, the powder may be used alone or applied to a substrate to form a coating of a laminate. The thickness of the coating may vary, but is typically about 1 millimeter or less, in some embodiments from about 0.5 to about 500 micrometers, and in some embodiments, from about 1 to about 100 micrometers. The material and size of the substrate to which the powder is applied may generally vary depending on the intended application. For example, the substrate may be formed from a metal (e.g., copper), plastic, ceramic, etc. Likewise, in certain embodiments, the substrate may have a foil-like structure in that it is relatively thin, such as having a thickness of about 500 micrometers or less, in some embodiments about 200 micrometers or less, and in some embodiments, from about 1 to about 100 micrometers. Of course, higher thicknesses may also be employed.

Any known technique for applying the powder to a substrate can generally be employed in the present invention. In one particular embodiment, the powder may be applied using a thermal spraying method, such as flame spraying, cold spraying, warm spraying, plasma spraying, etc. Thermal spraying generally involves the use of a working gas that is heated to a temperature lower than the melting point or softening temperature of the powder. The gas is accelerated to supersonic velocity so that the powder is brought into collision with the substrate at a high velocity to form a coating thereon. During this process, the powder may be heated to a certain temperature (e.g., above the melting temperature). The powder may be supplied to the working gas along the coaxial direction with the gas at a feed rate, such as from about 1 to about 200 g/minute, and in some embodiments, from about 10 to about 100 g/minute. The distance between the substrate and the nozzle tip of the spray apparatus may be from about 5 to about 100 mm, and the traverse velocity of the nozzle may be from about 10 to about 300 min/second.

Another process that may be employed to apply the powder to a substrate is solution coating. Namely, the present inventor has discovered that aromatic polyester may be generally soluble in a wide variety of solvents, which allows it to be readily formed into a solution and then coated onto a substrate. Any known technique for applying the solution to a substrate can generally be employed in the present invention. Some suitable solution deposition techniques may include, for instance, casting, roller coating, dip coating, spray coating, spinner coating, curtain coating, slot coating, screen printing, bar coating methods etc. Suitable solvents may include, for instance, aprotric solvents, protic solvents, as well as mixtures thereof. Examples of aprotic solvents may include halogen-containing solvents, such as methylene chloride, 1-chlorobutane, chlorobenzene, 1,1-dichloroethane, 1,2-dichloroethane, chloroform, and 1,1,2,2-tetrachloroethane; ether solvents, such as diethyl ether, tetrahydrofuran, and 1,4-dioxane; ketone solvents, such as acetone and cyclohexanone; ester solvents, such as ethyl acetate; lactone solvents, such as butyrolactone; carbonate solvents, such as ethylene carbonate and propylene carbonate; amine solvents, such as triethylamine and pyridine; nitrile solvents, such as acetonitrile and succinonitrile; amide solvents, such as N,N′-dimethylformamide, N,N′-dimethylacetamide, tetramethylurea and N-methylpyrrolidone; nitro-containing solvents, such as nitromethane and nitrobenzene; sulfide solvents, such as dimethylsulfoxide and sulfolane; and so forth. Among the above-listed aprotic solvents, amide solvents (e.g., N-methylpyrrolidone) are particularly suitable. Suitable protic solvents may likewise include, for instance, solvents having a phenolic hydroxyl group, such as phenolic compounds substituted with at least one halogen atom (e.g., fluorine or chlorine). Examples of such compounds include pentafluorophenol, tetrafluorophenol, o-chlorophenol, trichlorobenzene, and p-chlorophenol. Mixtures of various aprotic and/or protic solvents may also be employed.

Regardless of the solvents selected, the resulting solution typically contains solvents in an amount of from about 60 wt. % to about 99 wt. %, in some embodiments from about 70 wt. % to about 98 wt. %, and in some embodiments, from about 75 wt. % to about 95 wt. %. Likewise, the polymer of the present invention may constitute from about 1 wt. % to about 40 wt. %, in some embodiments from about 2 wt. % to about 30 wt. %, and in some embodiments, from about 5 wt. % to about 25 wt. % of the solution. The “solubility” of the polymer may likewise constitute from about 1% to about 40%, in some embodiments from about 2% to about 30%, and in some embodiments, from about 5% to about 25%. As discussed in more detail below, the “solubility” for a given polymer is calculated by dividing the maximum weight of the polymer that can be added to a solvent without phase separation by the weight of the solvent, and then multiplying this value by 100.

In one particular embodiment, the powder can be formed into a solution that is then cast onto a substrate as a film. If desired, the solvent(s) may be removed through a variety of different methods, such as by heating, pressure reduction, ventilation, etc. In one particular embodiment, the solvent(s) are vaporized under ventilation. The vaporization may occur in one or multiple steps. For examples, a drying step may initially be employed at a temperature of from about 50° C. to about 100° C. for about 10 minutes to about 2 hours, and thereafter a heat treatment step may be employed at a temperature from about 200° C. to about 450° C. for about 30 minutes to about 6 hours.

Once formed through a technique such as described above, the resulting coating may remain on the substrate or be removed therefrom (e.g., peeled away) for use in various different applications. For example, the coating or laminate can be employed in claddings, multi-layer print wiring boards for semiconductor package and mother boards, flexible printed circuit board, tape automated bonding, tag tape, packaging for microwave oven, shields for electromagnetic waves, probe cables, communication equipment circuits, etc. In one particular embodiment, a laminate is employed in a flexible printed circuit board that contains a conductive layer and an insulating coating formed as described herein. The conductive layer may be in the form of a metal plate or foil, such as those containing gold, silver, copper, nickel, aluminum, etc. (e.g., copper foil). The coating may be applied to the conductive layer using techniques such as described above (e.g., thermal spraying, casting, etc.), or the conductive layer may alternatively be applied to the coating using techniques such as ion beam sputtering, high frequency sputtering, direct current magnetron sputtering, glow discharge, etc. if desired, the coating may be subjected to a surface treatment on a side facing the conductive layer so that the adhesiveness between the coating and conductive layer is improved. Examples of such surface treatments include, for instance, corona discharge treatment, UV irradiation treatment, plasma treatment, etc. Adhesives may also be employed between the coating and the conductive layer as is known in the art. Suitable adhesives may include epoxy, phenol, polyester, nitrile, acryl, polyimide, polyurethane resins, etc.

The resulting laminate may have a two-layer structure containing only the coating and conductive layer. Alternatively, a multi-layered laminate may be formed, such as a three-layer structure in which conductive layers are placed on both sides of the coating, a five-layer structure in which coating and conductive layers are alternately stacked, and so forth. Regardless of the number of layers, various conventional processing steps may be employed to provide the laminate with sufficient strength. For example, the laminate may be pressed and/or subjected to heat treatment as is known in the art.

A variety of different techniques may be employed to form a printed circuit board from such a laminate structure. In one embodiment, for example, a photo-sensitive resist is initially disposed on the conductive layer and an etching step is thereafter performed to remove a portion of the conductive layer. The resist can then be removed to leave a plurality of conductive pathways that form a circuit. If desired, a cover film may be positioned over the circuit, which may also be formed from the polymer of the present invention. Regardless of how it is formed, the resulting printed circuit board can be employed in a variety of different electronic components. As an example, flexible printed circuit boards may be employed in desktop computers, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. Of course, the powder may also be employed in electronic components, such as described above, in devices other than printed circuit boards. For example, the powder may be used to form high density magnetic tapes, wire covering materials, etc. Other types of articles, such as molded articles (e.g., containers, bottles, cookware, etc.), may also be formed using the powder of the present invention.

The present invention may be better understood with reference to the following examples.

### Test Methods

Melt Viscosity:

The melt viscosity (Pa-s) may be determined in accordance with ISO Test No. 11443 at 350° C. or 370° C. and at a shear rate of 400 s⁻¹ or 1000 s⁻¹ using a Dynisco 7001 capillary rheometer. The rheometer orifice (die) had a diameter of 1 mm, length of 20 mm, L/D ratio of 20.1, and an entrance angle of 180°. The diameter of the barrel was 9.55 mm±0.005 mm and the length of the rod was 233.4 mm.

Intrinsic Viscosity:

The intrinsic viscosity (“IV”) may be measured in accordance with ISO-1628-5 using a 50/50 (v/v) mixture of pentafluorophenol and hexafluoroisopropanol. Each sample was prepared in duplicate by weighing about 0.02 grams into a 22 mL vial. 10 mL of pentafluorophenol (“PFP”) was added to each vial and the solvent. The vials were placed in a heating block set to 80° C. overnight. The following day 10 mL of hexafluoroisopropanol (“HFIP”) was added to each vial. The final polymer concentration of each sample was about 0.1%. The samples were allowed to cool to room temperature and analyzed using a PolyVisc automatic viscometer.

Solubility:

The solubility of a polymer can be determined by adding a predetermined amount of a polymer sample to a solution containing a predetermined amount of a solvent (e.g., N-methylpyrrolidone) and heating the resulting mixture from 150° C. to 180° C. for 3 hours. The mixture is considered soluble if it forms a clear to stable dispersion that does not undergo phase separation or separate into two layers upon standing at room temperature for a period of seven (7) days. If the mixture is determined to be soluble, additional amounts of the polymer sample are tested to determine the maximum amount of polymer that can be dissolved into the solvent. Likewise, if the mixture is determined to be insoluble, lower amounts of the polymer sample are tested. The “solubility” for a given polymer is calculated by dividing the maximum weight of the polymer that can be added to a solvent without phase separation by the weight of the solvent, and then multiplying this value by 100.

Particle Size Distribution:

In order to determine particle size and morphology, particles from each sample are examined using optical microscopy and image analysis. The particles are suspended in a water/glycol solution and then placed on glass slides for analysis. Representative images are taken of the samples. Over 1000 particles were measured for each sample. The “minimum diameter” of a particle is determined by measuring the length of the shortest line joining two points of the particle's outline and passing through its geometric center. The “maximum diameter” of the particle is determined by measuring the length of the longest line joining two points of the particle's outline and passing through its geometric center. The “mean diameter” of the particle is determined as the average length of diameters measured at 2 degree intervals and passing through the particle's geometric center.

### Comparative Example 1

A 2 L flask is charged with HBA (415.7 g), HNA (32 g), TA (151.2 g), BP (123 g), APAP (37.8 g) and 50 mg of potassium acetate. The flask is equipped with a C-shaped stirrer, thermal couple, gas inlet, and distillation head. The flask is placed under a low nitrogen purge and acetic anhydride (99.7% assay, 498 g) is added. The milky-white slurry is agitated at 75 rpm and heated to 140° C. over the course of 95 minutes using a fluidized sand bath. After this time, the mixture is then gradually heated to 360° C. steadily over 300 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 360° C., the nitrogen flow is stopped. The flask is evacuated below 20 psi and the agitation slows to 30 rpm over the course of 45 minutes. As the time under vacuum progresses, the mixture grows viscous. After 22 minutes, in the final vacuum step, no torque is recorded as seen by the strain on the agitator motor. The reaction is then stopped by releasing the vacuum and stopping the heat flow to the reactor. The flask is cooled and the polymer is recovered as a solid, dense yellow-brown plug.

To form a powder, the isolated polymer blocks are shred to form polymer flakes and then cryogenically ground using a cryogenic grinder (Model #SPEX 6700 Freezer/Mill). The chamber of the mill is filled with liquid nitrogen and then the cover is closed. The polymer sample (2-5 grams) and the impactor are placed in the grinding vial and then it is secured and closed. The timer and the impact frequency are set and the samples are ground for a predetermined time (e.g., 5 min or 30) and at a set frequency.

After being ground for 5 minutes, the resulting powder had the following particle size distribution:

| | Max Diameter | Min Diameter | Mean Diameter |
|---|---|---|---|
| | (μm) | (μm) | (μm) |
| Min of Particles | 5.0 | 5.8 | 5.8 |
| Measured | | | |
| Max of Particles | 2488.5 | 1195.7 | 1424.8 |
| Measured | | | |
| Mean of Particles | 120.3 | 57.5 | 83.4 |
| Measured | | | |
| Std. Dev. | 246.8 | 120.8 | 166.1 |

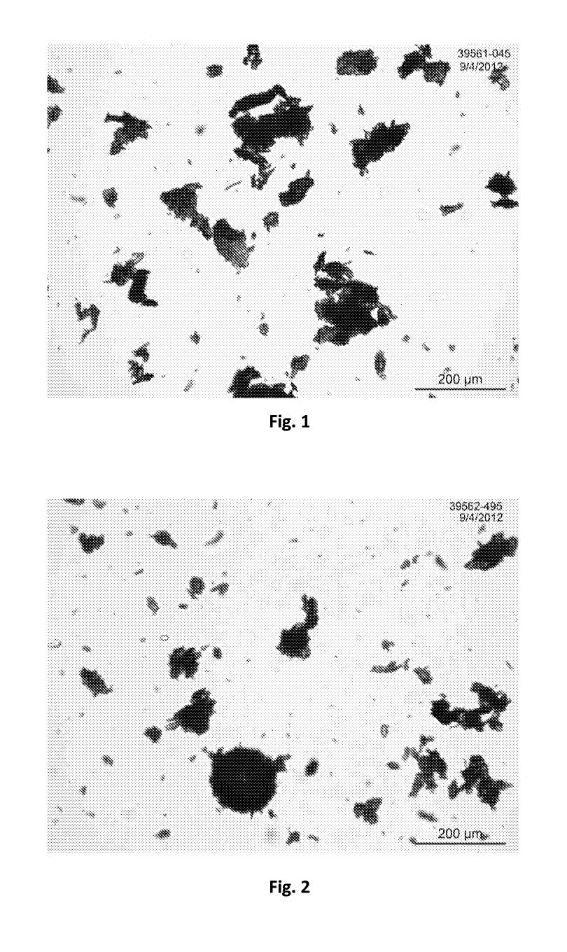

Thus, the mean diameter was 83.4 μm and the particles had a mean diameter distribution ranging from 5.8 μm to 1424.8 μm. An SEM microphotograph of the powder is also shown in FIG. 1.

Thermal properties of the powder are also determined. The melting temperature is 362° C., the crystallization temperature is 302° C., the melt viscosity at 1000 s⁻¹ and 350° C. is 325 Pa-s, and the melt viscosity at 400 s⁻¹ and 350° C. is 633 Pa-s.

### Example 1

A 2 L flask was charged with HBA (582 g), HNA (44.8 g), TA (211.7 g), BP (172 g), APAP (26.5 g), diphenyldihydroxy sulfone (43.8 g) and 65 mg of potassium acetate. The flask is equipped with a C-shaped stirrer, thermal couple, gas inlet, and distillation head. The flask is placed under a low nitrogen purge and acetic anhydride (99.7% assay, 715 g) is added. The milky-white slurry is agitated at 75 rpm and heated to 140° C. over the course of 95 minutes using a fluidized sand bath. After this time, the mixture is then gradually heated to 360° C. steadily over 300 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 360° C., the nitrogen flow is stopped. The flask is evacuated below 20 psi and the agitation slows to 30 rpm over the course of 45 minutes. As the time under vacuum progresses, the mixture grows viscous. After 85 minutes, in the final vacuum step, torque is recorded (43 in/oz) as seen by the strain on the agitator motor. The reaction is then stopped by releasing the vacuum and stopping the heat flow to the reactor. The flask is cooled and the polymer is recovered as a solid, dense yellow-brown plug.

A powder is formed in the manner described above. After being ground for 5 minutes, the powder had the following particle size distribution:

| | Max Diameter | Min Diameter | Mean Diameter |
|---|---|---|---|
| | (μm) | (μm) | (μm) |
| Min of Particles | 5.2 | 4.0 | 4.8 |
| Measured | | | |
| Max of Particles | 203.2 | 115.7 | 147.2 |
| Measured | | | |
| Mean of Particles | 42.3 | 19.3 | 28.7 |
| Measured | | | |
| Std. Dev. | 38.3 | 18 | 25.2 |

Thus, the mean diameter was 28.7 μm and the particles had a mean diameter distribution from 4.8 μm to 147.2 μm.

Thermal properties of the powder are also determined. The melt viscosity at 1000 s⁻¹ and 370° C. is 112 Pa-s and the melt viscosity at 400 s⁻¹ and 370° C. is 181 Pa-s. The melting temperature is 310° C. and the crystallization temperature is 270.32° C.

### Example 2

A 2 L flask was charged with HBA (582 g), HNA (44.8 g), TA (211.7 g), BP (172 g), diphenyldihydroxy sulfone (87.6 g) and 65 mg of potassium acetate. The flask is equipped with a C-shaped stirrer, thermal couple, gas inlet, and distillation head. The flask is placed under a low nitrogen purge and acetic anhydride (99.7% assay, 733 g) is added. The milky-white slurry is agitated at 75 rpm and heated to 140° C. over the course of 95 minutes using a fluidized sand bath. After this time, the mixture is then gradually heated to 360° C. steadily over 300 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 360° C., the nitrogen flow is stopped. The flask is evacuated below 20 psi and the agitation slows to 30 rpm over the course of 45 minutes. As the time under vacuum progresses, the mixture grows viscous. After 100 minutes, in the final vacuum step, torque is recorded (11 in/oz) as seen by the strain on the agitator motor. The reaction is then stopped by releasing the vacuum and stopping the heat flow to the reactor. The flask is cooled and the polymer is recovered as a solid, dense yellow-brown plug.

A powder is formed in the manner described above. After being ground for 5 minutes, the powder had the following particle size distribution:

| | Max Diameter | Min Diameter | Mean Diameter |
|---|---|---|---|
| | (μm) | (μm) | (μm) |
| Min of Particles | 5.4 | 4.0 | 4.9 |
| Measured | | | |
| Max of Particles | 220.2 | 111.4 | 154.3 |
| Measured | | | |
| Mean of Particles | 45.7 | 20.2 | 30.9 |
| Measured | | | |
| Std. Dev. | 43.1 | 19.1 | 28.1 |

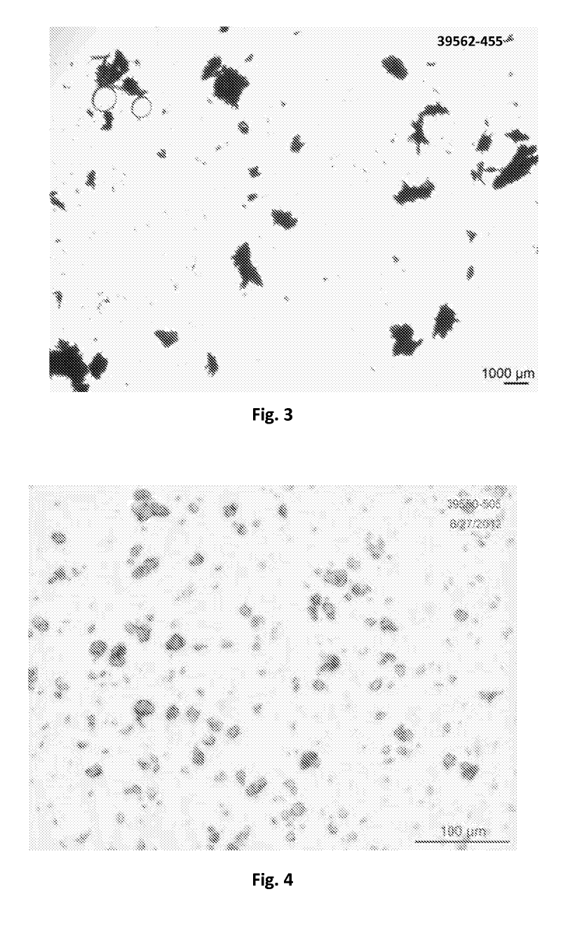

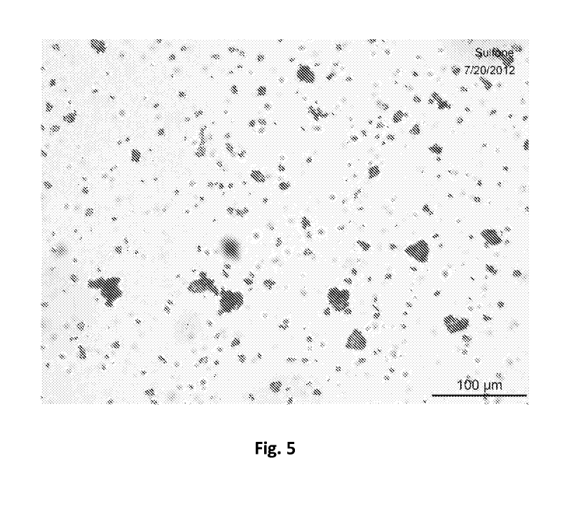

Thus, the mean diameter was 30.9 μm and the particles had a mean diameter distribution ranging from 4.9 μm to 154.3 μm. SEM microphotographs of the powder are also shown in FIGS. 2-3. As indicated, the particles have a more consistent size and shape than those of Comparative Example 1.

Thermal properties of the powder are also determined. The melt viscosity at 1000 s⁻¹ and 370° C. is 8 Pa-s and the melt viscosity at 400 s⁴ and 370° C. is 13.4 Pa-s. The melting temperature is 305° C. and the crystallization temperature is 270.13° C.

### Example 3

A 2 L flask was charged with HBA (582 g), HNA (44.8 g), TA (211.7 g), diphenyldihydroxy sulfone (318.8 g) and 64 mg of potassium acetate. The flask is equipped with a C-shaped stirrer, thermal couple, gas inlet, and distillation head. The flask is placed under a low nitrogen purge and acetic anhydride (99.7% assay, 733 g) is added. The milky-white slurry is agitated at 75 rpm and heated to 140° C. over the course of 95 minutes using a fluidized sand bath. After this time, the mixture is then gradually heated to 360° C. steadily over 300 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 360° C., the nitrogen flow is stopped. The flask is evacuated below 20 psi and the agitation slows to 30 rpm over the course of 45 minutes. As the time under vacuum progresses, the mixture grows viscous. When torque is recorded (40 in/oz) as seen by the strain on the agitator motor. The reaction is then stopped by releasing the vacuum and stopping the heat flow to the reactor. The flask is cooled and the polymer is recovered as a solid, dense yellow-brown plug.

A powder is formed in the manner described above. After being ground for 5 minutes, the powder had the following particle size distribution:

| | Max Diameter | Min Diameter | Mean Diameter |
|---|---|---|---|
| | (μm) | (μm) | (μm) |
| Min of Particles | 2.5 | 2.0 | 2.3 |
| Measured | | | |
| Max of Particles | 86.7 | 42 | 57.9 |
| Measured | | | |
| Mean of Particles | 13 | 6.1 | 9.2 |
| Measured | | | |
| Std. Dev. | 11.6 | 5.4 | 7.5 |

Thus, the mean diameter was 9.2 μm and the particles had a mean diameter distribution ranging from 2.3 μm to 57.9 μm. An SEM microphotograph of the powder is also shown in FIG. 4. As indicated, the particles are smaller and have a more consistent size and shape than those of Comparative Example 1,

Thermal properties of the powder are also determined. The melt viscosity at 1000 s⁻¹ and 370° C. is 67 Pa-s, and the melt viscosity at 400 s⁻¹ and 370° C. is 86 Pa-s.

### Example 4

A 2 L flask was charged with HBA (248.6 g), HNA (338.7 g), TA (100 g), IA (100 g), 4-aminophenyl sulfone (298 g) and 60 mg of potassium acetate. The flask is equipped with a C-shaped stirrer, thermal couple, gas inlet, and distillation head. The flask is placed under a low nitrogen purge and acetic anhydride (99.7% assay, 629 g) is added. The milky-white slurry is agitated at 75 rpm and heated to 140° C. over the course of 95 minutes using a fluidized sand bath. After this time, the mixture is then gradually heated to 350° C. steadily over 300 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 350° C., the nitrogen flow is stopped. The flask is evacuated below 20 psi and the agitation slows to 30 rpm. As the time under vacuum progresses, the mixture grows viscous and is stopped by releasing the vacuum and stopping the heat flow to the reactor. The flask is cooled and the polymer is recovered as a solid, dense yellow-brown plug.

A powder is formed in the manner described above, except that the grinding time is 30 minutes. The resulting powder had the following particle size distribution:

| | Max Diameter | Min Diameter | Mean Diameter |
|---|---|---|---|
| | (μm) | (μm) | (μm) |
| Min of Particles | 2.3 | 2.0 | 2.1 |
| Measured | | | |
| Max of Particles | 38.3 | 26.8 | 31.5 |
| Measured | | | |
| Mean of Particles | 9.2 | 5.2 | 7.3 |
| Measured | | | |
| Std. Dev. | 5.3 | 3.4 | 4.3 |

Thus, the mean diameter was 7.3 μm and the particles had a mean diameter distribution ranging from 2.1 μm to 31.5 μm. An SEM microphotograph of the powder is also shown in FIG. 4. As indicated, the particles are smaller and have a more consistent size and shape than those of Comparative Example 1.

Thermal properties of the powder are also determined. The melt viscosity at 1000 s⁻¹ and 350° C. is 103 Pa-s, and the melt viscosity at 400 s⁻¹ and 350° C. is 145 Pa-s.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A powder comprising a plurality of microparticles formed from an aromatic polyester having a melting temperature of from about 280° C. to about 380° C., wherein the microparticles have a mean size of from about 0.1 to about 200 micrometers and wherein at least about 50% by volume of the microparticles have a mean size within a range of from about 0.1 to about 200 micrometers.

2. The powder of claim 1, wherein the microparticles have a mean size of from about 0.1 to about 40 micrometers.

3. The powder of claim 1, wherein at least about 90% by volume of the microparticles have a mean size of from about 1 to about 50 micrometers.

4. The powder of claim 1, wherein the microparticles have an aspect ratio of from about 0.4 to about 2.0.

5. The powder of claim 1, wherein the microparticles are generally spherical.

6. The powder of claim 1, wherein the aromatic polyester contains aromatic biphenyl repeating units having the following general Formula I: 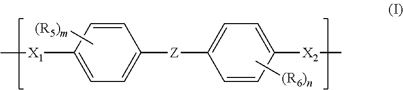
wherein,
R₅ and R₆ are independently halo, haloalkyl, alkyl, alkenyl, aryl, heteroaryl, cycloalkyl, or heterocyclyl;
m and n are independently from 0 to 4;
X₁ and X₂ are independently O, C(O), NH, C(O)HN, or NHC(O); and
Z is O or SO₂.

7. The powder of claim 6, wherein m and n Formula I are 0.

8. The powder of claim 6, wherein X₁, X₂, or both are O or NH.

9. The powder of claim 6, wherein Z is SO₂.

10. The powder of claim 9, wherein the biphenyl repeating units are derived from 4-(4-hydroxyphenyl)-sulfonylphenol, 4-(4-aminophenyl)sulfonylphenol, 4-(4-aminophenyl)sulfonylaniline, or a combination thereof.

11. The powder of claim 6, wherein Z is O.

12. The powder of claim 6, wherein the aromatic biphenyl repeating units constitute from about 0.5 mol. % to about 40 mol. % of the polyester.

13. The powder of claim 1, wherein the aromatic polyester contains repeating units derived from an aromatic dicarboxylic acid, aromatic hydroxycarboxylic acid, or a combination thereof.

14. The powder of claim 13, wherein the aromatic dicarboxylic acid includes terephthalic acid, isophthalic acid, or a combination thereof and wherein the aromatic hydroxycarboxylic acid includes 4-hydroxybenzoic acid.

15. The powder of claim 13, wherein the polyester further comprises one or more repeating units derived from an aromatic diol, aromatic amide, aromatic amine, or a combination thereof.

16. The powder of claim 1, wherein the aromatic polyester is wholly aromatic.

17. A method for forming a laminate, the method comprising applying a powder of claim 1 to a substrate.

18. The method of claim 17, wherein the powder is thermally sprayed onto the substrate.

19. The method of claim 17, wherein the powder is formed into a solution and thereafter applied to the substrate.

20. The method of claim 17, wherein the substrate is a conductive layer.

21. A method for forming a powder, the method comprising:
providing a thermotropic liquid crystalline aromatic polyester that has a melting temperature of from about 280° C. to about 380° C.; and
forming the polyester into microparticles having a mean size of from about 0.1 to about 200 micrometers.

22. The method of claim 21, wherein the microparticles are formed in the absence of a heat treatment step.

23. The method of claim 21, wherein the microparticles are formed in a single step.

24. The method of claim 21, wherein the microparticles are formed by grinding.
